(19) United States
(12) Patent Application Publication
(10) Pub. No.: US 2010/0289753 A1
(43) Pub. Date: Nov. 18, 2010

(54) ADJUSTING ORGANIZATION OF MEDIA CONTENT ON DISPLAY

(75) Inventors: Nicole Coddington, Kirkland, WA (US); Derek Sunday, Renton, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/466,217

(22) Filed: May 14, 2009

(51) Int. Cl. G06F 3/041; G06F 3/048

(52) U.S. Cl. 345/173; 715/825

(57) ABSTRACT

Embodiments related to organizing media content in a computing system are disclosed. One disclosed embodiment provides a method of organizing media content comprising displaying a boundary of an organizational container via a touch-sensitive display, displaying the set of two or more content items associated with the organizational container as a grouped stack within the boundary of the organizational container via the touch-sensitive display, and displaying an organizational mode selector via the touch-sensitive display, the organizational mode selector providing a plurality of selectable organizational modes. Next, the method comprises receiving a touch input directed toward the organizational mode selector, the touch input indicating a selected organizational mode from the plurality of selectable organizational modes, and reordering the set of two or more content items within the grouped stack arrangement from an initial order to an updated order defined by the selected organizational mode.

### BACKGROUND

Touch-sensitive displays may be used by computing devices to present graphical content and receive touch input from fingers, styluses, or other suitable objects in order to manipulate the graphical content. Various types of touch-sensitive displays are known for receiving touch input, including but not limited to capacitive, resistive and optical types. The use of a touch-sensitive display may enable the utilization of a broader range of touch-based inputs than other user input devices. However, current pointer-based graphical user interfaces configured for use with a mouse or other cursor control device may not be configured to utilize the capabilities offered by modern touch-sensitive displays.

### SUMMARY

Accordingly, various embodiments related to the organization of media content in a computing system via a touch-sensitive display are disclosed herein. For example, one disclosed embodiment provides a method of organizing media content in a computing system. The method comprises displaying a boundary of an organizational container via a touch-sensitive display. The method further comprises displaying a set of two or more content items associated with the organizational container as a grouped stack within the boundary of the organizational container via the touch-sensitive display, where the two or more content items are ordered in the grouped stack according to an initial order. The method further comprises displaying an organizational mode selector via the touch-sensitive display, where the organizational mode selector provides a plurality of selectable organizational modes. The method further comprises receiving a touch input directed toward the organizational mode selector, where the touch input indicates a selected organizational mode from the plurality of selectable organizational modes. The method further comprises reordering the set of two or more content items within the grouped stack arrangement from the initial order to an updated order defined by the selected organizational mode.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram depicting an embodiment of a computing device including a touch-sensitive display.

FIG. 2 is a schematic block diagram depicting an embodiment of content and executable instructions stored in the memory of the computing device of FIG. 1.

FIG. 3 is a process flow diagram depicting a method of organizing media content via a touch-sensitive display according to an embodiment of the present disclosure.

FIG. 4 is a diagram depicting an example graphical user interface that may be presented via a touch-sensitive display according to an embodiment of the present disclosure.

FIG. 5 is a diagram depicting the example graphical user interface of FIG. 4 at a later instance in time.

FIG. 6 is a diagram depicting the example graphical user interface of FIG. 5 at a later instance in time.

FIGS. 7 and 8 are diagrams of an example graphical user interface depicting another process by which organizational modes may be selected.

### DETAILED DESCRIPTION

Various embodiments are disclosed herein that relate to operation of a touch-sensitive display of a computing device. As mentioned above, many touch-sensitive displays for computing devices may not be configured to exploit the capabilities offered by a touch-sensitive use environment that may allow for a richer user experience. Therefore, various embodiments are disclosed herein that enable a user to reorder how content items are presented to the user by selecting an organizational mode via a touch-sensitive display. Before discussing the touch-sensitive display-related embodiments disclosed herein, an example touch-sensitive display environment is described.

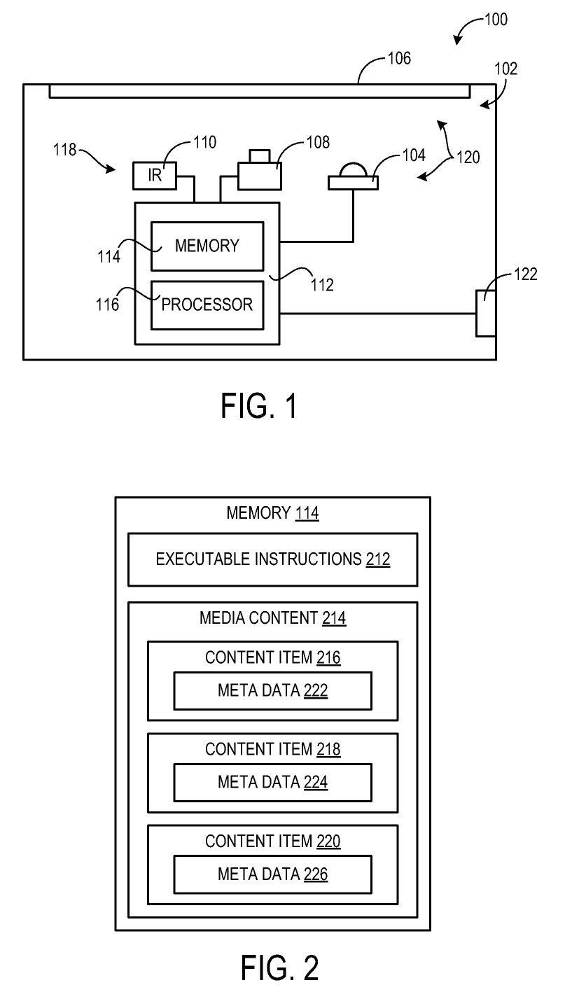

FIG. 1 is a block diagram depicting an embodiment of a computing device 100 including a touch-sensitive display 102. Computing device 100 forms part of a computing system in which other computing devices may interact via communication networks. In the particular embodiment of FIG. 1, touch-sensitive display 102 of computing device 100 is configured to detect touch input (e.g., a touch gesture) via optical detection. However, it should be appreciated that a touch-sensitive display may be configured to detect touch input via resistive or capacitive detection as an alternative to or in addition to the optical detection depicted by the embodiment of FIG. 1.

Touch-sensitive display 102 includes a display system 120 configured to present graphical content. Display system 120 includes a display surface 106 and an image source 104. As a non-limiting example, image source 104 may include a projection device configured to present an image (e.g., graphical content) on display surface 106. Touch-sensitive display 102 further includes a touch input device 118 configured to receive a touch input (e.g., a touch gesture) responsive to an object (e.g., a finger) contacting or approaching display surface 106 of display system 120. In other embodiments, any other suitable display system may be used, including but not limited to a liquid crystal display panel.

Touch input device 118 may include an image sensor 108 for acquiring an infrared image of the display surface 106 to detect objects, such as fingers, contacting or approaching display surface 106. Display surface 106 may comprise various structures such as diffuser layers, anti-glare layers, etc. not shown in detail herein. Touch input device 118 may further include an illuminant 110, depicted herein as an infrared light source, configured to illuminate a backside of the display surface 106 with infrared light. Through operation of one or more of the image source 104, the image sensor 108, and the illuminant 110, the touch-sensitive display may be configured to detect one or more touches contacting display surface 106.

Computing device 100 further includes a controller 112 having memory 114 and a processor 116. In some embodiments, computing device 100 may further include an audio speaker 122 for outputting audio content.

FIG. 2 is a block diagram depicting an example embodiment of memory 114 of computing device 100 of FIG. 1. As shown in FIG. 2, memory 114 may include executable instructions 212 (e.g., one or more programs) stored thereon that when executed by a processor (e.g., processor 116) are configured to perform one or more of the processes and methods described herein.

Memory 114 may further include media content 214 including one or more content items. The term “content item” as used herein refers to the representation of a content item on a graphical user display, and may include representations of any suitable type of content, including but not limited to electronic files, documents, images, audio, video, software applications, etc. For example, media content 214 includes content item 216, content item 218, and content item 220. It will be appreciated that media content 214 may include any number of content items. Computing device 100 may be configured to output (e.g., play or perform) the content items via one or more of touch-sensitive display 102 and audio speaker 122.

In some embodiments, the content items may include meta data. For example, FIG. 2 shows meta data 222 associated with content item 216. Similarly, meta data 224 is associated with content item 218 and meta data 226 is associated with content item 220. This meta data may indicate information relating to the content item, including one or more of a type of content, a title of the content item, an author of the content item, etc. Furthermore, in some embodiments, the meta data may indicate categorization information (e.g., an informational tag) for the content item. For example, a content item may be categorized as a pertaining to a “People” category or a “Places” category. In some embodiments, the categorization information may be assigned by the user to the content item. For example, the user may tag the content item with an informational tag that is associated with the content item as meta data.

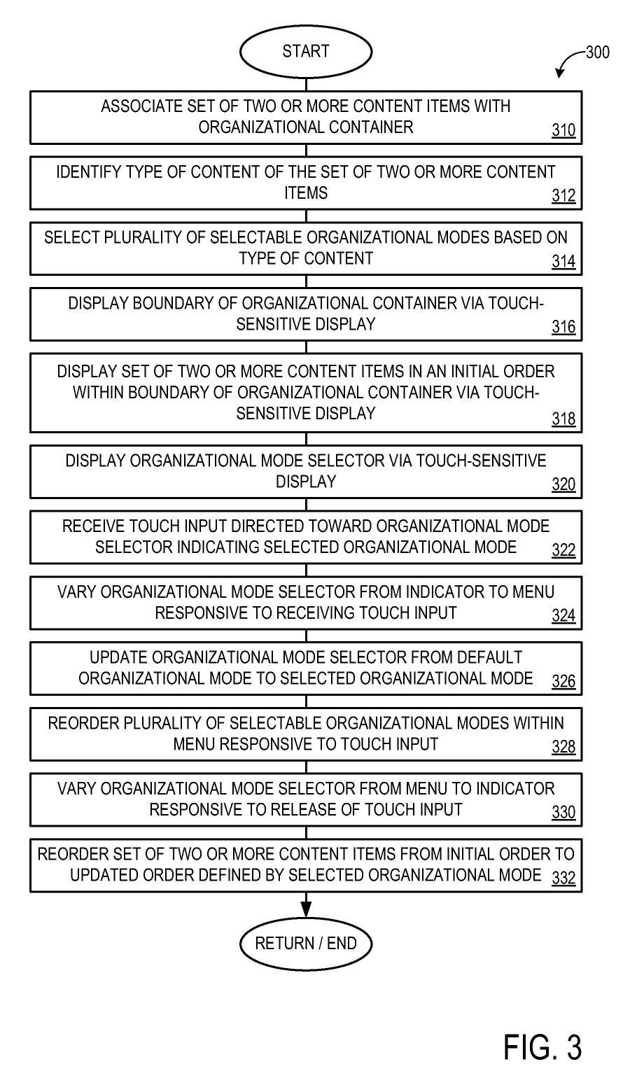

FIG. 3 is a process flow diagram depicting a method 300 of organizing media content via a touch-sensitive display according to an embodiment of the present disclosure. It should be appreciated that method 300 may be performed by computing device 100 of FIG. 1, or any other suitable computing device including a touch-sensitive display. As such, method 300 may be embodied as executable instructions stored in memory of the computing device.

At 310, the method includes associating a set of two or more content items with an organizational container. The term “organizational container” as used herein signifies a dynamic grouping mechanism with which media content (such as images, videos, and audio content etc.) may be associated. As a non-limiting example, the organizational container may comprise a directory or subdirectory of a digital file system held in memory of the computing device or in memory that is accessible to the computing device.

In at least some embodiments, an organizational container enables a user to view content items and manipulate the content items and the organizational container in various interactive ways. For example, a user may cause the computing device to associate a set of content items with an organizational container by moving the set of content items into the organizational container by directing touch-input to the touch-sensitive display.

The set of content items associated with the organizational container may be controlled or navigated as a group or individually, depending upon the touch input gestures that are directed to the touch-sensitive display. For example, if an action is applied to the organizational container by a user the action may be applied to each content item associated with that organizational container. As another example, a user may move the set of content items associated with an organizational container to a different location of the display surface by using touch input to drag and drop the organizational container at the desired location.

At 312, the method includes identifying a type of content of the set of two or more content items. In some embodiments, the computing device may be configured to reference the meta data associated with each content item to identify the type of content. Alternatively or additionally, the computing device may be configured to identify the type of content based on a file extension of the content item, such as .jpg, .mov, .mp3, etc. It should be appreciated that the computing device may be configured to recognize any suitable type of a content item. For example, the computing device may be configured to identify whether each content item is a type of audio content, video content, or image content.

At 314, the method includes identifying a plurality of selectable organizational modes based on the type of content identified at 312. In at least some embodiments, the selectable organizational modes that are identified by the computing device may differ depending on the type of content that is identified at 312. As a non-limiting example, the computing device may be configured to identify one or more selectable organizational modes for image content if the type of content identified at 312 is image content.

For example, the selectable organizational modes identified for image content may include categories such as “People”, “Places”, “Animals”, “Work”, “Beaches”, “Cities”, “Flowers”, etc. In contrast, the computing device may be configured to identify one or more selectable organizational modes for video content if the type of content identified at 312 is video content. For example, the selectable organizational modes identified for video content may include categories such as “Movies”, “Television Shows”, “Home Videos”, etc. As yet another example, the selectable organizational modes for audio content may include categories such as “Jazz”, “Pop”, and “Classical”, as well as “Artist”, “Album”, etc. In some embodiments, the computing device may identify the selectable organizational modes by referencing the meta data of the set of two or more content items associated with the organizational container.

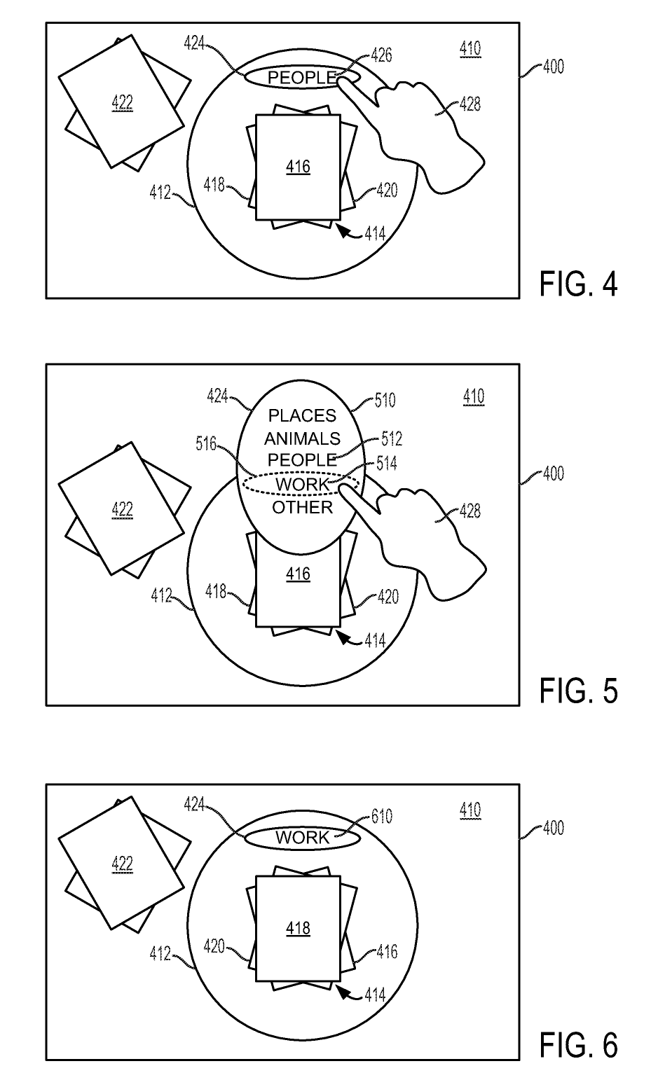

At 316, the method includes displaying a boundary of the organizational container via a touch-sensitive display. As a non-limiting example, the computing device may display the boundary over a background canvas as depicted in FIG. 4. In at least some embodiments, the boundary may be displayed as a circle, an oval, a rectangle, or other suitable shape. In at least some embodiments, the boundary of the organizational container may not be displayed via the touch-sensitive display.

At 318, the method includes displaying the set of two or more content items according to an initial order within the boundary of the organizational container. In some examples, the set of two or more content items may be displayed as a grouped stack as depicted in FIG. 4. However, in other examples, the set of two or more content items may be displayed in a tiled or grid arrangement (e.g., where two or more content items are presented side-by-side) a slide show arrangement (e.g., where a focus content item is presented at a substantially larger scale than the other content items of the set), or any other suitable arrangement. In at least some embodiments, the computing device may enable the user to select whether the set of two or more content items is displayed in a grouped stack arrangement, a tiled arrangement, or a slide show arrangement.

At 320, the method includes displaying an organizational mode selector via the touch-sensitive display. The organizational mode selector may provide a plurality of selectable organizational modes. In some embodiments, an organizational mode may define how two or more content items are to be ordered relative to each other when displayed to the user via the touch-sensitive display.

As one example, the organizational mode selector includes a category menu and the plurality of selectable organizational modes includes a plurality of different categories of content within the set of two or more content items. For example, the different categories of content may include a “People” category, a “Places” category, an “Animals” category, and a “Work” category by which media content may be ordered. The user may reorder the content items associated with the organizational container (e.g. changing an order in which the content items are stacked) by changing which organizational mode is selected.

Furthermore, in some embodiments, the initial order of the set of two or more content items is a default order and the organizational mode selector depicts a default organizational mode of the plurality of selectable organizational modes in conjunction with the display of the initial order. For example, where the default organizational mode is a “People” category, the organizational mode may depict the “People” category and the set of two or more content items may be displayed in an initial order in accordance with the “People” category (e.g. such that photographs of people are highest in the content stack).

In some embodiments, the organizational mode selector may be displayed as an alphanumeric string, and in other embodiments may be displayed as an icon or other symbol, wherein the icon may include a graphical representation of the selected organizational mode. The term “indicator” may be used herein to describe any of these representations of the organizational mode in situations where a menu of all selectable organizational modes is hidden. Where a user has not yet indicated a selected organizational mode (e.g., via touch input) an indicator representing default organizational mode may be presented to the user as the organizational mode selector, instead of a menu showing all organizational modes. In at least some embodiments, the organizational mode selector (i.e. indicator) may be displayed within the boundary of the organizational container, for example, as depicted in FIG. 4.

At 322, the method includes receiving a touch input directed toward the organizational mode selector. The touch input may indicate a selected organizational mode from the plurality of selectable organizational modes. FIGS. 5, 7, and 8 provide several processes by which the touch input may indicate the selected organizational mode.

At 324, the method includes varying the organizational mode selector displayed via the touch-sensitive display from an indicator to a menu of the plurality of selectable organizational modes responsive to receiving the touch input. For example, the indicator may be expanded to reveal the menu including the plurality of selectable organizational modes. The touch input may indicate the selected organizational mode from the plurality of selectable organizational modes based upon which organizational mode the touch input is directed. For example, a user may indicate a selected organizational mode by directing the touch input to a desired organizational mode to be applied to the set of two or more content items associated with the organizational container.

At 326, the method includes updating the organizational mode selector that is displayed via the touch-sensitive display from the default organizational mode to the selected organizational mode indicated by the touch input. For example, where the organizational mode selector displays a “People” category and the selected organizational mode indicated by the touch input is a “Work” category, the organizational mode selector may be updated to display the “Work” category.

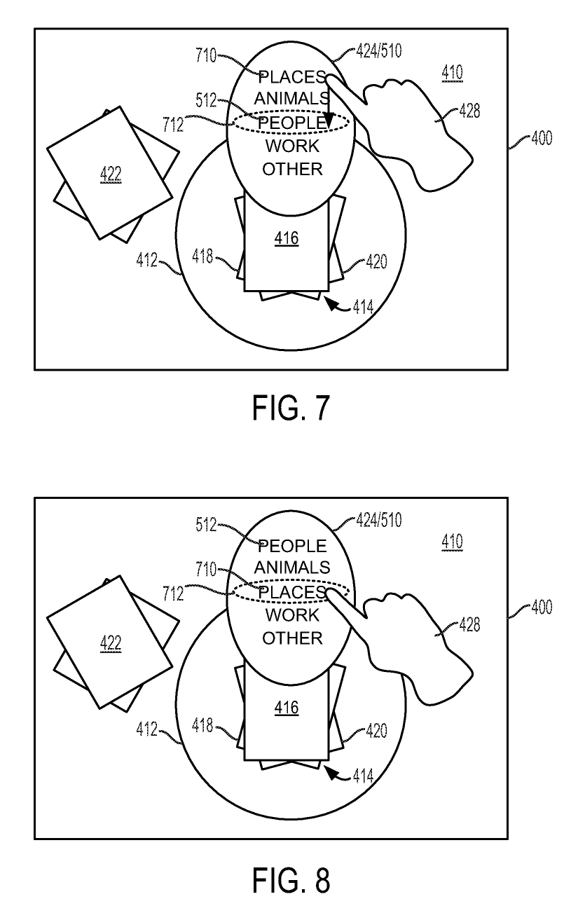

In some embodiments, the method at 328 may include reordering the plurality of selectable organizational modes within the menu responsive to the touch input. For example, the selected organizational mode may be indicated by a predefined position of the selected organizational mode relative to other organizational modes of the plurality of selectable organizational modes within the menu. For example, a user may indicate the selected organizational mode by dragging and dropping an organizational mode to a selection region of the menu. Process 328 is illustrated in greater detail by FIGS. 7 and 8. In some embodiments, process 328 may be omitted. For example, an order of the plurality of organizational modes may remain static within the menu regardless of the selected organizational mode indicated by the touch input.

At 330, the method includes varying the organizational mode selector displayed via the touch-sensitive display from the menu to the indicator responsive to release of the touch input from the touch-sensitive display. In some embodiments, the indicator may present the selected organizational mode. For example, where the selected organizational mode is a “Work” category, the indicator may include a depiction of the “Work” category.

In some embodiments, the method at 330 may further include delaying varying the organizational mode selector from the menu to the indicator for a first period of time after release of the touch input from the touch-sensitive display. As one example, the first period of time may be longer than a second period of time between when the touch input is received at the touch-sensitive display and the organizational mode selector is varied from the indicator to the menu. In this way, the computing device may maintain the organizational mode selector as the menu to provide the user with the opportunity to select a different organizational mode (e.g., redirect the selected organizational mode) if the touch input was released by the user pre-maturely or erroneously.

At 332, the method includes reordering the set of two or more content items from the initial order to an updated order defined by the selected organizational mode. For example, where the set of two or more content items are displayed in an initial order in a grouped stack arrangement, the computing device may be configured to reorder one or more of the content items within the grouped stack according to the selected organizational mode. In some embodiments, one or more of the content items of the set of two or more content items may be reordered to the top of the grouped stack if the selected organizational mode includes a category to which the one or more content items belong. In some embodiments, the computing device may be configured to reference the meta data (e.g., an informational tag) of the content items to identify which content items belong to the category identified by the selected organizational mode.

Similarly, with a tiled arrangement or a slide show arrangement, the set of two or more content items may be reordered according to the selected organizational mode. For example, the computing device may be configured to reorder one or more of the content items that belong to a category identified by the selected organizational mode so that the one or more content items are displayed to the user via the touch-sensitive display. In this way, a user may filter which content items are presented to the user by varying the selected organizational mode that is applied to the organizational container.

In some embodiments, the method at 332 may further include delaying reordering the set of two or more content items after release of the touch input from the touch-sensitive display. For example, the reordering of the set of two or more content items may be performed by the computing device when the organizational mode selector is varied from the menu to the indicator. In this way, the computing device may delay reordering the set of two or more content items for a period of time to provide the user with the opportunity to select a different organizational mode (e.g., redirect the selected organizational mode) if the touch input was released by the user pre-maturely or erroneously. It should be appreciated that the computing device may be configured to utilize a delay of any suitable duration between release of the touch input and reordering of the set of two or more content items, including no delay.

Hence, method 300 may be used to reorder a set of two or more content items responsive a single touch input that contacts the touch-sensitive display, is dragged across the touch-sensitive display to indicate the selected organizational mode, and is released from the touch-sensitive display to initiate reordering of the media content according to the selected organizational mode.

Method 300 may also be used to reorder a set of two or more content items responsive to multiple touch inputs. For example, a first touch input that is directed toward the organizational mode selector may cause the computing device to vary the organizational mode selector from the indicator to the menu. A second touch input that is directed to the menu may indicate the selected organizational mode by dragging the selected organizational mode to a predefined position in the menu. A third touch input that is directed at the selected organizational mode at the predefined position in the menu may be used to confirm the user's selection, whereby the release of the third touch input from the touch-sensitive display may cause the computing device to reorder the set of two or more content items and vary the organizational mode selector from the menu to an indicator.

FIG. 4 is a diagram depicting an example graphical user interface 400 that may be presented via a touch-sensitive display (e.g., touch-sensitive display 102 of FIG. 1) according to an embodiment of the present disclosure. Graphical user interface 400 may include a background canvas 410 that is displayed by the touch-sensitive display over which various content items may be presented to a user. In this example, a boundary 412 of an organizational container is displayed over background canvas 410.

In FIG. 4, a set of content items 414 including content item 416, content item 418, and content item 420, are displayed within boundary 412. For example, the set of content items 414 may be associated with the organizational container of boundary 412. By contrast, content item 422 may not be associated with the organizational container of boundary 412 and hence may be presented outside of boundary 412. FIG. 4 further depicts the set of content items 414 displayed in an initial order as a grouped stack.

A user may cause the computing device to associate content item 422 with the organizational container by directing touch input to content item 422, dragging content item 422 into boundary 412, and releasing the touch input from the touch-sensitive display to drop content item 422. Once content item 422 is associated with the organizational container it is added to set of content items 414 and may be reordered in response to selected organizational modes. A user may also disassociate a content item from the organizational container my removing the content item from within boundary 412.

An organizational mode selector 424 is displayed via the touch-sensitive display as an indicator 426. In the example embodiment of FIG. 4, indicator 426 depicts a category “People”. A hand 428 of a user is shown providing a touch input to the touch-sensitive display that is directed toward organizational mode selector 424.

FIG. 5 is a diagram depicting the example graphical user interface 400 of FIG. 4 at a later instance in time after initially receiving the touch input from hand 428. In FIG. 5, organizational mode selector 424 has been varied by the computing device from indicator 426 to a menu 510 of a plurality of selectable organizational modes responsive to receiving the touch input.

In the embodiment of FIG. 5, menu 510 is a category menu and the plurality of selectable organizational modes includes a plurality of different categories of content within set of content items 414. For example, a “People” category 512 that was presented by indicator 426 in FIG. 4 is included in menu 510. Menu 510 includes other categories, including a “Work” category 514. Each of these categories is a different organizational mode that may be selected by the user.

For example, in FIG. 5, hand 428 is selecting “Work” category 514 via touch input received by the touch-sensitive display. In this way, the touch input that is received at the touch-sensitive display can indicate a selected organizational mode. In some embodiments, an indicator 516 may be displayed for indicating the selected organizational mode. As a non-limiting example, indicator 516 may highlight, resize, bold, or a change a color of the selected organizational mode.

FIG. 6 is a diagram depicting the example graphical user interface 400 of FIG. 5 at a later instance in time after the touch input from hand 428 has been released from the touch-sensitive display. In FIG. 6, organizational mode selector 424 has been varied by the computing device from menu 510 to an indicator 610 responsive to release of the touch input from the touch-sensitive display. Indicator 610 depicts the category “Work” which was the selected organizational mode indicated by the touch input in FIG. 5. Hence, in response to the touch input, the set of content items 414 is reordered from the initial order of FIG. 4 to an updated order of FIG. 6 as defined by the selected organizational mode. For example, content item 418 has been moved to the top of the grouped stack and content item 416 has been moved to the bottom of the grouped stack.

FIGS. 7 and 8 depict another process by which organizational modes may be selected within a menu through multiple touch inputs. In FIG. 7, menu 510 of organizational mode selector 424 is again depicted. Touch input received via hand 428 is shown dragging a “Places” category 710 into a selection region 712 which is initially occupied by the “People” category 512. As shown in FIG. 8, the “Places” category 710 has replaced the “People” category 512 as the selected organizational mode within selection region 712. Hence, upon release of touch input from the touch-sensitive display, the “Places” category 710 will become the selected organizational mode causing the set of content items 414 to be reordered accordingly. In other embodiments, the selection region 712 may instead by translated within menu 510 among the plurality of organizational modes to indicate the selected organizational mode.

It will be appreciated that the computing devices described herein may be any suitable computing device configured to execute the programs described herein, including but not limited to the embodiment of FIG. 1. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. In a computing system, a method of organizing media content, comprising:
displaying a boundary of an organizational container via a touch-sensitive display;
displaying a set of two or more content items associated with the organizational container as a grouped stack within the boundary of the organizational container via the touch-sensitive display, the two or more content items ordered in the grouped stack according to an initial order;
displaying an organizational mode selector via the touch-sensitive display, the organizational mode selector providing a plurality of selectable organizational modes;
receiving a touch input directed toward the organizational mode selector, the touch input indicating a selected organizational mode from the plurality of selectable organizational modes; and
reordering the set of two or more content items within the grouped stack arrangement from the initial order to an updated order defined by the selected organizational mode.

2. The method of claim 1, where the organizational mode selector includes a category menu, and where the plurality of selectable organizational modes includes a plurality of different categories of content within the set of two or more content items.

3. The method of claim 1, further comprising:
identifying a type of content of the set of two or more content items; and
identifying the plurality of selectable organizational modes based on the type of content.

4. The method of claim 1, where the initial order is a default order and where the organizational mode selector depicts a default organizational mode of the plurality of selectable organizational modes in conjunction with the display of the initial order.

5. The method of claim 4, further comprising, updating the organizational mode selector that is displayed via the touch-sensitive display from the default organizational mode to the selected organizational mode indicated by the touch input.

6. The method of claim 1, where displaying the organizational mode selector includes displaying the organizational mode selector within the boundary of the organizational container.

7. The method of claim 1, further comprising, varying the organizational mode selector displayed via the touch-sensitive display from an indicator to a menu of the plurality of selectable organizational modes responsive to receiving the touch input.

8. The method of claim 7, further comprising, varying the organizational mode selector displayed via the touch-sensitive display from the menu to an indicator responsive to release of the touch input from the touch-sensitive display.

9. The method of claim 8, further comprising:
delaying varying the organizational mode selector from the menu to the indicator for a first period of time after release of the touch input from the touch-sensitive display, where the first period of time is longer than a second period of time between when the touch input is received at the touch-sensitive display and the organizational mode selector is varied from the indicator to the menu; and
delaying reordering the set of two or more content items after release of the touch input from the touch-sensitive display.

10. The method of claim 7, further comprising, reordering the plurality of selectable organizational modes within the menu responsive to the touch input; and where the selected organizational mode is indicated by a predefined position of the selected organizational mode relative to other organizational modes of the plurality of selectable organizational modes within the menu.

11. A computing device, comprising:
a processor; and
memory comprising executable instructions stored thereon that when executed by the processor are configured to:
associate a set of two or more content items with an organizational container;
identify a type of content of the set of two or more content items associated with the organizational container; and
display a boundary of the organizational container via a touch-sensitive display of the computing device;
display the set of two or more content items within the boundary of the organizational container via the touch-sensitive display, the two or more content items ordered within the boundary according to an initial order;
identify a plurality of selectable organizational modes based on the type of content of the set of two or more content items associated with the organizational container;
display an organizational mode selector associated with the organizational container via the touch-sensitive display;
receive a touch input directed toward the organizational mode selector, the touch input indicating a selected organizational mode from the plurality of selectable organizational modes; and
reorder the set of two or more content items within the boundary from the initial order to an updated order defined by the selected organizational mode.

12. The computing device of claim 11, where the memory further comprises executable instructions stored thereon that when executed by the processor are configured to:
display the set of two or more content items in a grouped stack arrangement.

13. The computing device of claim 11, where the memory further comprises executable instructions stored thereon that when executed by the processor are configured to:
display the set of two or more content items in a grid arrangement.

14. The computing device of claim 11, where the memory further comprises executable instructions stored thereon that when executed by the processor are configured to:
display the set of two or more content items in a slide show arrangement.

15. The computing device of claim 11, where the memory further comprises executable instructions stored thereon that when executed by the processor are configured to:
display the organizational mode selector within the boundary of the organizational container.

16. The computing device of claim 11, where the memory further comprises executable instructions stored thereon that when executed by the processor are configured to:
vary the organizational mode selector displayed via the touch-sensitive display from an indicator to a menu of the selectable organizational modes responsive to receiving the touch input.

17. The computing device of claim 16, where the memory further comprises executable instructions stored thereon that when executed by the processor are configured to:
vary the organizational mode selector displayed via the touch-sensitive display from the menu to an indicator responsive to release of the touch input from the touch-sensitive display.

18. The computing device of claim 17, where the memory further comprises executable instructions stored thereon that when executed by the processor are configured to:
delay varying the organizational mode selector from the menu to the indicator for a first period of time after release of the touch input from the touch-sensitive display, where the first period of time is longer than a second period of time between when the touch input is received at the touch-sensitive display and the organizational mode selector is varied from the indicator to the menu; and
delay reordering the set of two or more content items after release of the touch input from the touch-sensitive display.

19. In a computing system, a method of organizing media content, comprising:
associating a set of two or more content items with an organizational container;
identifying a type of content of the set of two or more content items;
displaying a boundary of the organizational container via a touch-sensitive display;
displaying the set of two or more content items as a grouped stack within the boundary of the organizational container via the touch-sensitive display, the two or more content items ordered in the grouped stack according to an initial order;
identify a plurality of selectable organizational modes based on a type of content of the set of two or more content items associated with the organizational container;
displaying an organizational mode selector within the boundary via the touch-sensitive display, the organizational mode selector providing the plurality of selectable organizational modes;
receiving a touch input directed toward the organizational mode selector, the touch input indicating a selected organizational mode from the plurality of selectable organizational modes;
varying the organizational mode selector displayed via the touch-sensitive display from an indicator to a menu of the selectable organizational modes responsive to receiving the touch input;
reordering the set of two or more content items within the grouped stack arrangement from the initial order to an updated order defined by the selected organizational mode responsive to release of the touch input from the touch-sensitive display; and
varying the organizational mode selector displayed via the touch-sensitive display from the menu to an indicator responsive to release of the touch input from the touch-sensitive display.

20. The method of claim 19, further comprising:
delaying varying the organizational mode selector from the menu to the indicator for a first period of time after release of the touch input from the touch-sensitive display, where the first period of time is longer than a second period of time between when the touch input is received at the touch-sensitive display and the organizational mode selector is varied from the indicator to the menu; and
delaying reordering the set of two or more content items after release of the touch input from the touch-sensitive display.
